(19) United States
(12) Patent Application Publication
(10) Pub. No.: US 2022/0236771 A1
(43) Pub. Date: Jul. 28, 2022

(54) FOLDABLE KEYBOARD COVER

(71) Applicant: SAMSUNG ELECTRONICS CO., LTD., Suwon-si (KR)

(72) Inventors: Dahyun LEE, Suwon-si (KR); Bosoon KANG, Suwon-si (KR); Namsu KIM, Suwon-si (KR); Jieun MYUNG, Suwon-si (KR); Jinhoo LEE, Suwon-si (KR); Jungwon LEE, Suwon-si (KR)

(21) Appl. No.: 17/719,798

(22) Filed: Apr. 13, 2022

Related U.S. Application Data
(63) Continuation of application No. PCT/KR2020/016533, filed on Nov. 20, 2020.

(30) Foreign Application Priority Data
Nov. 21, 2019 (KR) 10-2019-0150294

(51) Int. Cl. G06F 1/16

(52) U.S. Cl. CPC G06F 1/1656; G06F 1/1616; G06F 1/1681; G06F 1/1667

(57) ABSTRACT

A foldable keyboard cover according to various embodiments of the disclosure is configured to be attached to an electronic device, in which a first housing and a second housing are connected to each other to be foldable via a hinge unit. The foldable keyboard cover comprises: a first cover configured to face the first housing of the electronic device and including a first attachment unit configured to be attached to the first housing, a second cover configured to face the second housing of the electronic device and including a second attachment unit configured to be attached to the second housing, a first folding unit configured to face the hinge unit of the electronic device and connecting the first cover and the second cover to be foldable about a first folding axis, and a physical keyboard including a first keyboard arranged on at least a partial region of the first cover and a second keyboard arranged on at least a partial region of the second cover. The first folding unit may comprise an elastic material wherein the first cover and the second cover are configured to cover the first housing and the second housing in a state in which the first housing and the second housing of the electronic device are folded.

### CROSS-REFERENCE TO RELATED APPLICATIONS

This application is a continuation of International Application No. PCT/KR2020/016533 designating the United States, filed on Nov. 20, 2020, in the Korean Intellectual Property Receiving Office and claiming priority to Korean Patent Application No. 10-2019-0150294, filed on Nov. 21, 2019, in the Korean Intellectual Property Office, the disclosures of which are incorporated by reference herein in their entireties.

### BACKGROUND

### Field

The disclosure relates to a foldable keyboard cover including a physical keyboard and foldable in a way to become a case of a foldable electronic device.

### Description of Related Art

As so-called foldable electronic devices that are foldable are continuously released, the demand for a case capable of protecting such a foldable electronic device is also increased. Furthermore, users who replace conventional computers, such as a desktop and a notebook, by combining a physical keyboard with a tablet are also recently increasing.

In such a situation, the need for an accessory including a physical keyboard while performing a case function, which may be used in a foldable electronic device, is increasing.

### SUMMARY

Embodiments of the disclosure may provide a foldable keyboard cover in which a foldable cover designed to be foldable and to be coupled with a foldable electronic device in a sense of unity and a physical keyboard connected to the foldable electronic device and capable of a physical key input are combined.

A foldable keyboard cover configured to be attached to an electronic device in which a first housing and a second housing are connected to be foldable by a hinge according to various example embodiments of the disclosure includes: a first cover configured to face the first housing of the electronic device and including a first attachment part configured to be attached to the first housing, a second cover configured to face the second housing of the electronic device and including a second attachment part configured to be attached to the second housing, a first folding part configured to face the hinge part of the electronic device and to connect the first cover and the second cover to be foldable about a first folding axis, and a physical keyboard including a first keyboard disposed in at least some area of the first cover and a second keyboard disposed in at least some area of the second cover. The first folding part may include a material having an elastic force wherein the first cover and the second cover are configured to cover the first housing and the second housing in a state in which the first housing of the electronic device and the second housing are folded.

A foldable keyboard cover configured to be attached to an electronic device in which a first housing and a second housing are connected to be foldable by a hinge according to various example embodiments of the disclosure includes: a first cover configured to face the first housing of the electronic device and including a first attachment part configured to be attached to the first housing, a second cover configured to face the second housing of the electronic device and including a second attachment part configured to be attached to the second housing, a first folding part configured to face the hinge of the electronic device and connect the first cover and the second cover to be foldable about a first folding axis, and a physical keyboard including a first keyboard disposed in at least some area of the first cover and a second keyboard disposed in at least some area of the second cover. The first attachment part of the first cover and the second attachment part of the second cover may be configured to be attached to the first housing and second housing of the electronic device on a surface opposite to a surface on which a display of the electronic device is disposed.

According to various example embodiments of the disclosure, the foldable keyboard cover can be combined with a foldable electronic device in a sense of unity, and can protect the foldable electronic device against an external impact, and for example, can prevent and/or reduce an external alien substance from entering a hinge portion by protecting the hinge portion, that is, a weak portion of the foldable electronic device.

Furthermore, the usability of the foldable electronic device can be increased by providing a key input interface through a physical keyboard and supporting the foldable electronic device so that the state in which the foldable keyboard cover and the foldable electronic device form a specified angle can be maintained.

### BRIEF DESCRIPTION OF THE DRAWINGS

In relation to the description of the drawings, the same or similar reference numerals may be used with respect to the same or similar elements. Additionally, the above and other aspects, features and advantages of certain embodiments of the present disclosure will be more apparent from the following detailed description, taken in conjunction with the accompanying drawings, in which:

FIG. 1 is a block diagram illustrating an example electronic device within a network environment according to various embodiments;

FIG. 2 is a diagram illustrating an example foldable electronic device which may be combined with a foldable keyboard cover according to various embodiments;

FIG. 3 is a diagram illustrating an example foldable keyboard cover according to various embodiments;

FIG. 4 is a diagram illustrating an example form in which the foldable electronic device and the foldable keyboard cover are combined according to various embodiments;

FIG. 5 is a diagram illustrating the state in which the foldable electronic device and the foldable keyboard cover are combined according to various embodiments;

FIG. 6A is a cross-sectional view of the foldable keyboard cover according to various embodiments;

FIG. 6B is a diagram illustrating an example form in which the foldable keyboard cover is folded according to various embodiments;

FIGS. 7A and 7B are diagrams illustrating an example process of the foldable keyboard cover standing according to various embodiments; and

FIGS. 8A and 8B are diagrams illustrating example adjustment of a standing angle of the foldable electronic device through the foldable keyboard cover according to various embodiments.

### DETAILED DESCRIPTION

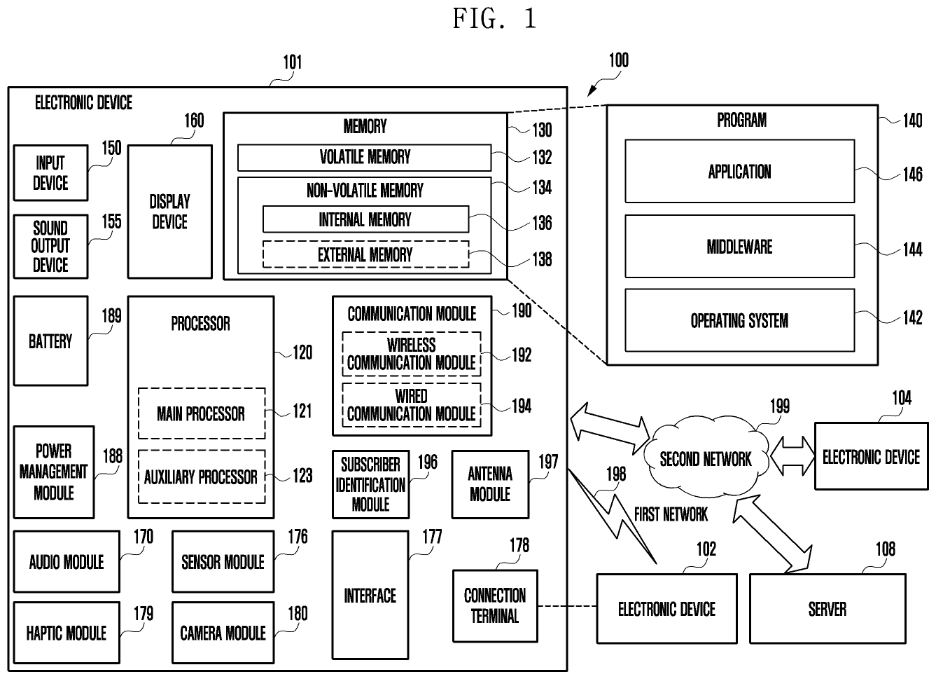

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In various embodiments, at least one (e.g., the display device 160 or the camera module 180) of the components may be omitted from the electronic device 101, or one or more other components may be added in the electronic device 101. In various embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

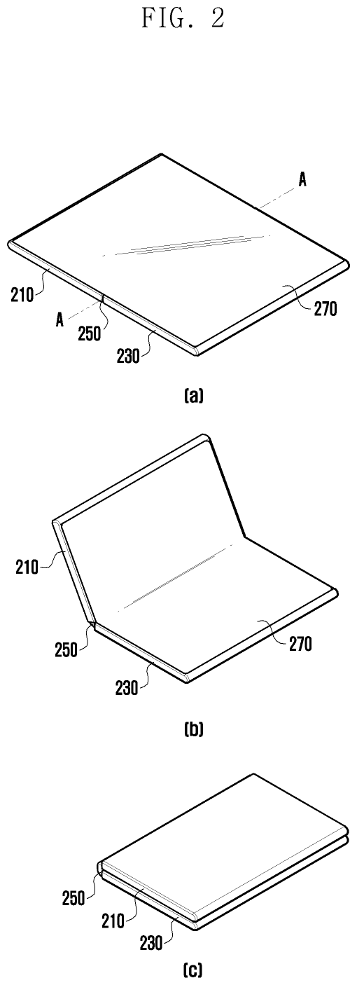

FIG. 2 is a diagram illustrating an example foldable electronic device which may be combined with a foldable keyboard cover according to various embodiments.

With reference to FIG. 2, the foldable electronic device may include a first housing 210, a second housing 230, a hinge part 250 and a display 270. The first housing 210 and the second housing 230 may be disposed on both sides of a folding axis (e.g., line A-A in FIG. 2), and may have shapes generally symmetrical to each other with respect to the folding axis.

The first housing 210 and the second housing 230 may be connected to be foldable centering around the folding axis by the hinge part 250. The first housing 210 and the second housing 230 may have a different angle or distance formed by the first housing 210 and the second housing 230 in an unfolding state (e.g., FIG. 2(a)), an intermediate state (e.g., FIG. 2(b)), or a folding state (e.g., FIG. 2(c)).

Parts for performing various functions of the foldable electronic device may be embedded in at least one of the first housing 210 and the second housing 230. Examples of such parts may include a processor (e.g., the processor 120 in FIG. 1), a memory (e.g., the memory 130 in FIG. 1), an audio module (e.g., the audio module 170 in FIG. 1), a sensor module (e.g., the sensor module 176 in FIG. 1), a communication module (e.g., the communication module 190 in FIG. 1), a battery (e.g., the battery 189 in FIG. 1), etc.

The display 270 (e.g., the display device 1600 in FIG. 1) may be elongated to an area that connects the first housing 210 and the second housing 230, and may be disposed on the first housing 210 and the second housing 230. The display 270 may refer, for example, to the display 270 at least some area of which may be deformed in a plane or a curved surface. According to various embodiments, the display 270 may be a foldable display which may operate normally although the first housing 210 and the second housing 230 are repeatedly folded or unfolded.

Hereinafter, a direction in which the display 270 is disposed in the foldable electronic device is defined as a front, and a direction opposite to the display 270 may be referred to as a rear.

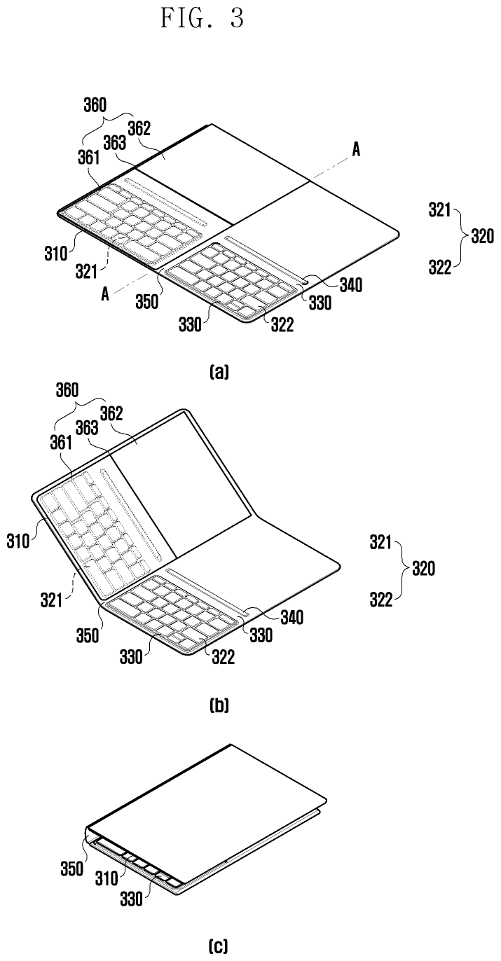

FIG. 3 is a diagram illustrating an example foldable keyboard cover according to various embodiments.

According to various embodiments, the foldable keyboard cover may include a first cover 310, a second cover 330, a first folding part 350 and a physical keyboard 320.

According to various embodiments, the first cover 310 may be formed in a sheet shape. The first cover 310 may be formed to have an area corresponding to the area of the first housing 210 of the foldable electronic device so that the first housing 210 of the foldable electronic device can be protected. The end of the first cover 310 and the end of the first housing 210 may be matched with each other. The first cover 310 may be manufactured using various materials. For example, the first cover 310 may be manufactured using a material, such as natural/artificial leather or natural/synthetic fiber.

According to various embodiments, the second cover 330 may be formed in a sheet shape. The second cover 330 may be formed to have an area corresponding to the area of the second housing 230 of the foldable electronic device so that the second housing 230 of the foldable electronic device can be protected. The end of the second cover 330 and the end of the second housing 230 may be matched with each other. The second cover 330 may be manufactured using various materials. For example, the second cover 330 may be manufactured using a material, such as natural/artificial leather or natural/synthetic fiber.

According to various embodiments, the first folding part 350 may connect the first cover 310 and the second cover 330 to be foldable. The first folding part 350 is a portion facing the hinge part 250 of the foldable electronic device, and may cover the hinge part 250 in the state in which the foldable electronic device and the foldable keyboard cover have been combined. The first folding part 350 may connect the first cover 310 and the second cover 330 to be foldable centering around a first folding axis (e.g., line A-A in FIG. 3). The first folding part 350 may be manufactured using a flexible material so that a characteristic thereof can be maintained without any damage although the first folding part 350 is repeatedly folded or unfolded. The first cover 310 and the second cover 330 may have a different angle or distance formed by the first cover 310 and the second cover 330 in an unfolding state (e.g., FIG. 3(a)), an intermediate state (e.g., FIG. 3(b)), and a folding state (e.g., FIG. 3(c)).

According to various embodiments, the physical keyboard 320 may be various types of keyboards equipped with a switch capable of recognizing a physical force applied by a user. For example, the physical keyboard 320 may be a membrane type of keyboard including a membrane-switch or a pantograph type of keyboard including a scissor-switch. In addition, the physical keyboard 320 according to various embodiments of the disclosure may be various types of keyboards capable of receiving a physical force.

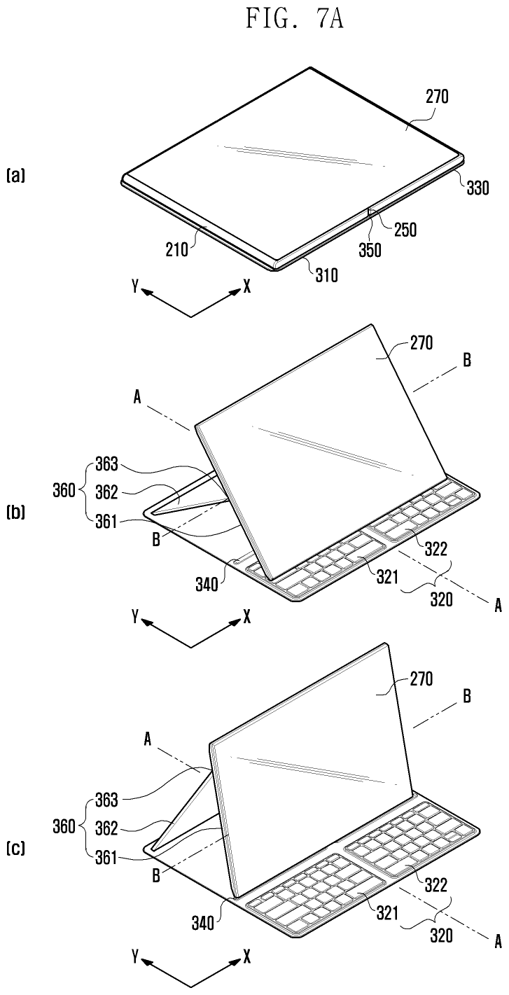

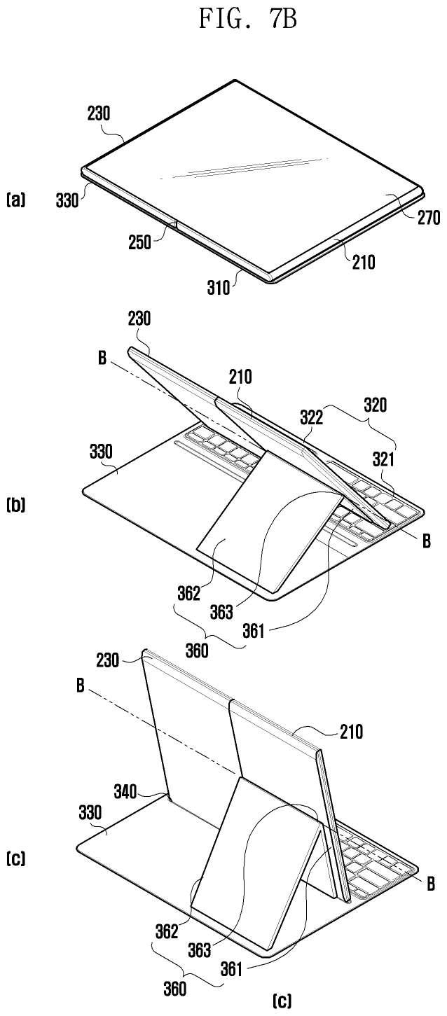

According to various embodiments, the physical keyboard 320 may include a first keyboard 321 and a second keyboard 322. The first keyboard 321 may be disposed in at least some area of the first cover 310. The second keyboard 322 may be disposed in at least some area of the second cover 330. The first keyboard 321 may include at least some of a plurality of keys included in the physical keyboard 320. The second keyboard 322 may include the remaining keys other than the keys included in the first keyboard 321 among the plurality of keys included in the physical keyboard 320. The first keyboard 321 disposed in the first cover 310 may have a state covered by a first support part 361 of a cover stand 360. As illustrated in FIG. 7A, when the first support part 361 and a second support part 362 are folded by a second folding part 363 of the cover stand 360, the first keyboard 321 of the physical keyboard 320 may be exposed to the outside.

According to various embodiments, the cover stand 360 may support the foldable electronic device at a specified angle with respect to the foldable keyboard cover. The cover stand 360 may include the first support part 361, the second support part 362 and the second folding part 363.

According to various embodiments, the first support part 361 may be disposed to correspond to at least some area of the first cover 310.

According to various embodiments, the second support part 362 may be connected to the first cover 310. At least one surface of the second support part 362 and at least one surface of the first cover 310 may be connected. The connected portion may connect the first cover 310 and the second support part 362 in the state in which the first cover 310 and the second support part 362 are permitted to form a specified angle. The connected portion may be disposed to correspond to the remaining portion other than a portion of the first cover 310 that corresponds to the first support part 361. The area of the first support part 361 and second support part 362 of the cover stand 360 may correspond to the area of the first cover 310. According to various embodiments, an area formed by the first support part 361 and second support part 362 of the cover stand 360 may not correspond to an area of the first cover 310. For example, the area of the first support part 361 and second support part 362 of the cover stand 360 may be greater than or smaller than the area of the first cover 310.

According to various embodiments, the second folding part 363 may connect the first support part 361 and the second support part 362 in a way to be foldable centering around a second folding axis (e.g., refer to line B-B in FIGS. 7A and 7B). The second folding axis may be a rotation axis elongating in a direction perpendicular to the first folding axis.

According to various embodiments, a stand support part 340 may support the front of the foldable electronic device stood by the cover stand 360. The stand support part 340 may have a protrusion form protruding from and formed on the first cover 310 and the second cover 330.

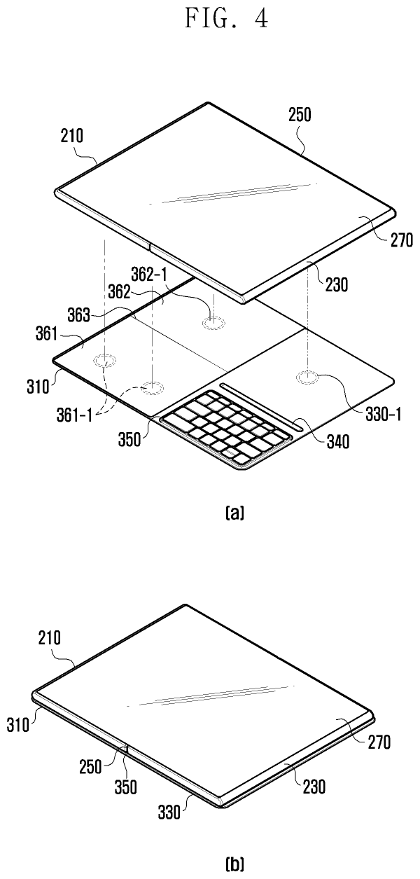

FIG. 4 is a diagram illustrating an example form in which the foldable electronic device and the foldable keyboard cover are combined according to various embodiments.

As illustrated in FIG. 4, the foldable electronic device and the foldable keyboard cover may be combined. A first attachment part 361-1 and 362-1 of the first cover 310 may be attached to the rear of the first housing 210. A second attachment part 330-1 of the second cover 330 may be attached to the rear of the second housing 230. For example, the first attachment part 361-1 and 362-1 and the second attachment part 330-1 may be magnetic substances. A metal object to which a magnetic substance may be attached may be disposed within the first housing 210 and second housing 230 of the foldable electronic device. Furthermore, for example, the first attachment part 361-1 and 362-1 and the second attachment part 330-1 may be metal objects. A magnetic substance may be disposed within the first housing 210 and second housing 230 of the foldable electronic device. In some cases, the first attachment part 361-1 and 362-1 and the second attachment part 330-1 may be magnetic substances or metal objects. An object to which the first attachment part 361-1 and 362-1 may be attached may be disposed within the first housing 210. An object to which the second attachment part 330-1 may be attached may be disposed within the second housing 230.

According to various embodiments, the first attachment part 361-1 and 362-1 may include a first standing attachment part 361-1 and a second standing attachment part 362-1. The first standing attachment part 361-1 may be disposed in the first support part 361. The second standing attachment part 362-1 may be disposed in the second support part 362. A coupling force of the first standing attachment part 361-1 and the foldable electronic device may be stronger than a coupling force of the second standing attachment part 362-1 and the foldable electronic device. For example, as illustrated in FIG. 4, the number of magnetic substances of the first standing attachment part 361-1 may be greater than the number of magnetic substances of the second standing attachment part 362-1. In some cases, the coupling force of the first standing attachment part 361-1 may be made greater than the coupling force of the second standing attachment part 362-1 by making the area of the first standing attachment part 361-1 greater than the area of the second standing attachment part 362-1.

The foldable keyboard cover may be attached to the rear of the foldable electronic device in order to protect the foldable electronic device against an external impact or prevent and/or reduce an external alien substance from approaching the foldable electronic device. For example, the first folding part 350 of the foldable keyboard cover may be disposed to cover the hinge part 250 of the foldable electronic device in order to improve the durability of the foldable electronic device by blocking an external alien substance from entering the hinge part 250 of the foldable electronic device.

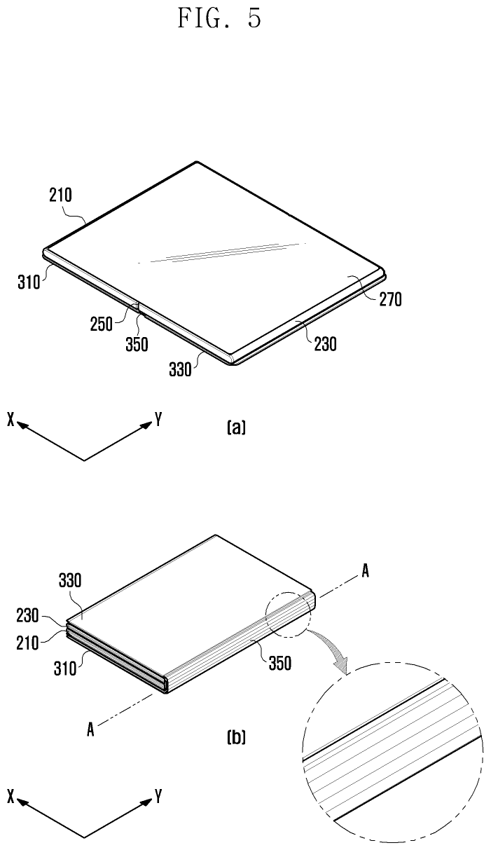

FIG. 5 is a diagram illustrating the state in which the foldable electronic device and the foldable keyboard cover have been combined according to various embodiments.

According to various embodiments, the first folding part 350 of the foldable keyboard cover may be made of a material that is elastically deformed. As described above, the first cover 310 and the second cover 330 may be folded by rotating centering around a first folding axis (e.g., line A-A in FIG. 5).

For example, a state unfolded as in FIG. 5(a) may change into a state folded as in FIG. 5(b). The first folding part 350 may be elastically deformed in a direction (e.g., an X direction in FIG. 5) perpendicular to the first folding axis. As the first folding part 350 is elastically deformed, the foldable keyboard cover may cover the entire foldable electronic device in the state completely folded as in FIG. 5(b). The first cover 310 may completely cover the first housing 210, and the second cover 330 may completely cover the second housing 230. In a process of the first cover 310 and the second cover 330 being folded, the first folding part 350 may be elastically deformed in a direction (e.g., the X direction in FIG. 5) perpendicular to the first folding part, so the first cover 310 and the second cover 330 may completely cover the first housing 210 and the second housing 230.

Accordingly, even in the state in which the foldable keyboard cover has been completely folded as in FIG. 5(b), the foldable keyboard cover can protect the entire external surface of the foldable electronic device.

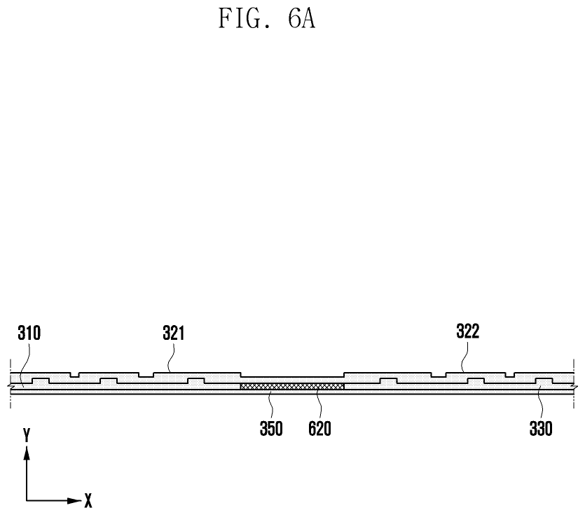

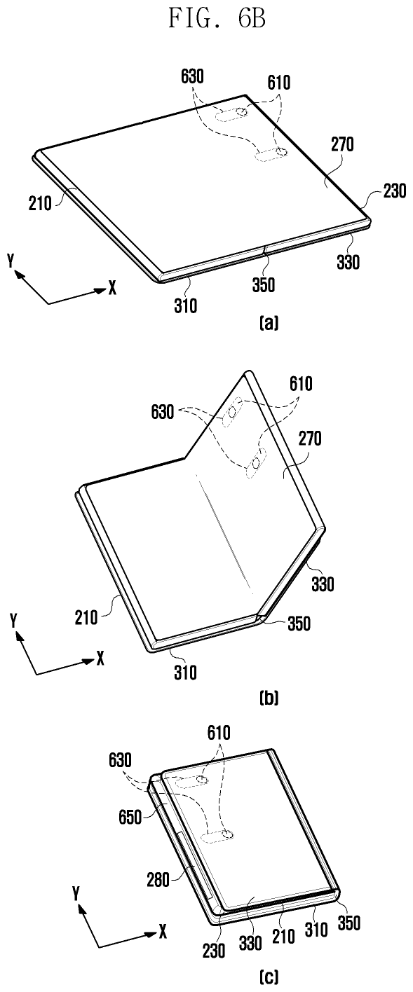

FIG. 6A is a cross-sectional view of the foldable keyboard cover according to various embodiments. FIG. 6B is a diagram illustrating an example in which the foldable keyboard cover is folded according to various embodiments.

According to various embodiments, a reinforcement member 620 may be disposed within the first folding part 350 of the foldable keyboard cover. The reinforcement member 620 permits the folding of the first cover 310 and the second cover 330, but may pressurize the first cover 310 and the second cover 330 in a direction (e.g., an X direction in FIG. 6A) perpendicular to the first folding axis in the state in which the first cover 310 and the second cover 330 have been completely unfolded. The reinforcement member 620 can suppress a wrinkle phenomenon which may occur in the first folding part 350 in the state in which the foldable keyboard cover has been completely unfolded. In this case, the wrinkle phenomenon may refer, for example, to a phenomenon occurring due to a stress difference within the first folding part 350 in the states in which the foldable keyboard cover has been completely folded and unfolded. For example, tensile strength may act on the first folding part 350 in the state in which the foldable keyboard cover has been completely unfolded, and compression stress may occur in the first folding part 350 in the state in which the foldable keyboard cover has been completely folded. Due to such a stress difference, wrinkles may occur in the first folding part 350 in the state in which the foldable keyboard cover has been completely unfolded. The reinforcement member 620 can prevent and/or reduce such a wrinkle phenomenon of the first folding part 350.

According to various embodiments, the reinforcement member 620 may be made of a material having high shape maintenance. The reinforcement member 620 having high shape maintenance can suppress the wrinkle phenomenon because the reinforcement member 620 has strong properties that a state of the reinforcement member 620 returns to an original state thereof.

According to various embodiments, as illustrated in FIG. 6B, a second attachment part 630 of the second cover 330 may include a plurality of magnetic substances extending in a direction (e.g., an X direction in FIG. 6B) perpendicular to a first folding axis (e.g., line A-A in FIG. 6B). The second attachment parts 330-1 may be arranged at specified intervals in a direction (e.g., the Y direction in FIG. 6B) of the first folding axis. The second attachment part 330-1 may be magnetically combined with an attachment part 610 of the foldable electronic device. According to various embodiments, the attachment part 610 of the foldable electronic device may be circular metal having the same diameter as the width of the second attachment part 330-1.

(a) of FIG. 6B is a diagram illustrating the state in which the foldable keyboard cover has been completely unfolded. (b) of FIG. 6B is a diagram illustrating the state in which the foldable keyboard cover has been folded at a specified angle. (c) of FIG. 6B is a diagram illustrating the state in which the foldable keyboard cover has been completely folded. If the first folding part 350 of the foldable keyboard cover is fabricated using a material not having a high degree of elastic deformation unlike the first folding part 350 illustrated in FIG. 5, the second cover 330 may slip over on a surface of the second housing 230 in a process of the foldable keyboard cover being folded. At this time, the attachment part 610 of the foldable electronic device may be moved in a direction in which the second attachment part 330-1 extends. As the attachment part 610 of the foldable electronic device is moved in the direction in which the second attachment part 330-1 extends, the slip of the second cover 330 for the second housing 230 may be guided. Although the second cover 330 slips over on a surface of the second housing 230 in a process of the foldable keyboard cover being folded, the second cover 330 may slip over in the state in which the end of the second cover 330 has been matched with the end of the second housing 230. The second attachment part 330-1 may guide the slip of the second cover 330 for the second housing 230, and thus can prevent or reduce a phenomenon in which the second cover 330 slips over in an oblique direction with respect to the second housing 230 in a process of the foldable keyboard cover being folded.

According to various embodiments, unlike in the case illustrated in FIG. 6B, the attachment part of the foldable electronic device may be formed in a shape extending in a direction perpendicular to the first folding axis, and the second attachment part may be a circular magnetic substance having a diameter corresponding to the width of the attachment part of the foldable electronic device.

According to various embodiments, since the second cover 330 may slip over with respect to the second housing 230 in a process of the foldable keyboard cover being folded, a part of the second housing 230 may be exposed to the outside as in (c) of FIG. 6B. According to an embodiment, the foldable electronic device may include an auxiliary display 280 in a portion through which a part of the second housing 230 is exposed by the slip of the second cover 330. A user can check some information, such as the notification of the foldable electronic device, through the auxiliary display 280 even in the state in which the foldable keyboard cover has been completely folded.

FIGS. 7A and 7B are diagrams illustrating an example process of the foldable keyboard cover standing according to various embodiments.

According to various embodiments, the cover stand 360 may include the first support part 361, the second support part 362 and the second folding part 363. The second folding part 363 may connect the first support part 361 and the second support part 362 in a way to be foldable. The first support part 361 and the second support part 362 may be folded centering around a second folding axis (e.g., line B-B in FIGS. 7A and 7B). The second folding axis may be a rotation axis elongating in a direction (e.g., the X direction in FIG. 7A) perpendicular to the first folding axis.

In the state (a) of FIGS. 7A and 7B, the second standing attachment part 362-1 of the second support part 362 may have a state attached to the second housing 230 of the foldable electronic device. When the first support part 361 and the second support part 362 start to be folded in a state such as a state (b) of FIGS. 7A and 7B, the second standing attachment part 362-1 (refer to FIG. 4) may be attached to and detached from the second housing 230 of the foldable electronic device. As described above with reference to FIG. 4, the coupling force of the first standing attachment part 361-1 and the second housing 230 may be stronger than the coupling force of the second standing attachment part 362-1 and the second housing 230. In a process of the first support part 361 and the second support part 362 being folded, the first standing attachment part 361-1 maintains the state continuously attached to the second housing 230, and the second standing attachment part 362-1 may be relatively easily attached to and detached from the second housing 230.

As in (c) of FIGS. 7A and 7B, the first support part 361 and the second support part 362 may be folded until one surface of the foldable electronic device is supported by the stand support part 340. According to various embodiments, the stand support part 340 may have a protrusion shape elongated in a direction (e.g., the X direction in FIG. 7A) perpendicular to the first folding axis and protruded in the direction in which the physical keyboard 320 is disposed.

Since the first support part 361 supports the second housing 230 of the foldable electronic device in the state in which the first support part 361 and the second support part 362 have been folded at a specified angle, the cover stand 360 supports the rear of the foldable electronic device and the stand support part 340 supports the front of the foldable electronic device. Accordingly, the foldable electronic device and the foldable keyboard cover may be maintained in the state in which the foldable electronic device and the foldable keyboard cover form a specified angle.

In the foldable keyboard cover according to various embodiments, the cover stand 360 may be disposed only at a location corresponding to the first cover 310. As described above, the first support part 361 and second support part 362 of the foldable keyboard cover may be formed to corresponding to an area of the first cover 310. A thickness in the state in which the foldable keyboard cover has been completely folded can be minimized or reduced because the cover stand 360 is disposed only in the first cover 310 corresponding to only one side of the foldable keyboard cover. According to various embodiments, the cover stand 360 may also be disposed at a location corresponding to the second cover 330 in addition to the first cover 310.

According to various embodiments, the physical keyboard 320 of the foldable keyboard cover may have a standby state and an active state. The standby state may refer, for example, to a state in which the physical keyboard 320 has been deactivated. In this state, an input to the physical keyboard 320 may be ignored. The active state may refer, for example, to a state in which the physical keyboard 320 has been activated. In this state, an input to the physical keyboard 320 may be transmitted to the foldable electronic device. The standby state and active state of the physical keyboard 320 may be changed through various methods. For example, a state of the physical keyboard 320 may switch from the standby state to the active state based on a trigger that the second support part 362 of the cover stand 360 is detached from the foldable electronic device. When the second attachment part 330-1 (refer to FIG. 4) of the second support part 362 is detached from the second housing 230, a state of the physical keyboard 320 may switch to the active state. When the second attachment part 330-1 is attached to the second housing 230, a state of the physical keyboard 320 may switch to the standby state. Furthermore, for example, a state of the physical keyboard 320 may switch to the active state in response to an activation command from the foldable electronic device. Furthermore, for example, a state of the physical keyboard 320 may switch from the standby state to the active state based on a trigger that one surface of the foldable electronic device comes into contact with the stand support part 340. A contact between the stand support part 340 and the foldable electronic device may be detected through a sensor disposed in a portion of the foldable electronic device, which comes into contact with the stand support part 340. In some cases, a sensor disposed in the stand support part 340 may detect a contact between the foldable electronic device and the stand support part 340.

In addition, a state of the physical keyboard 320 may switch from the standby state to the active state through various triggers. As described above, the physical keyboard 320 having the standby state and the active state can minimize and/or reduce battery consumption when not used.

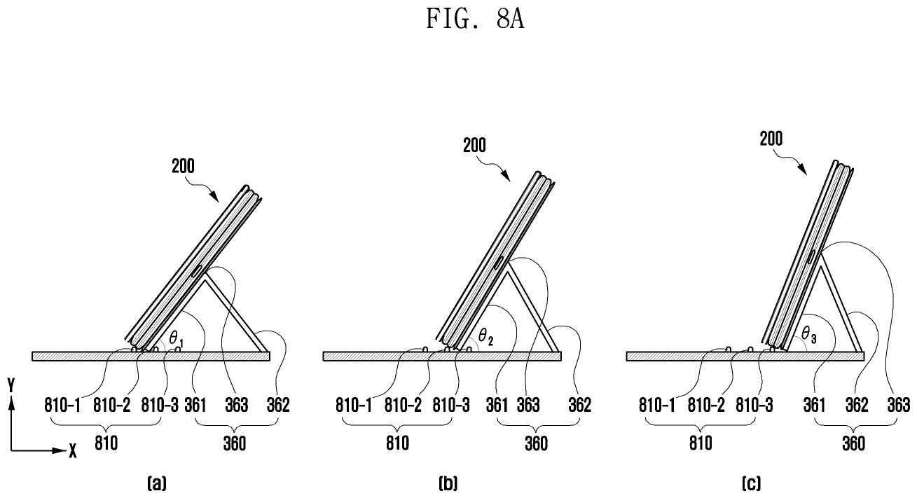

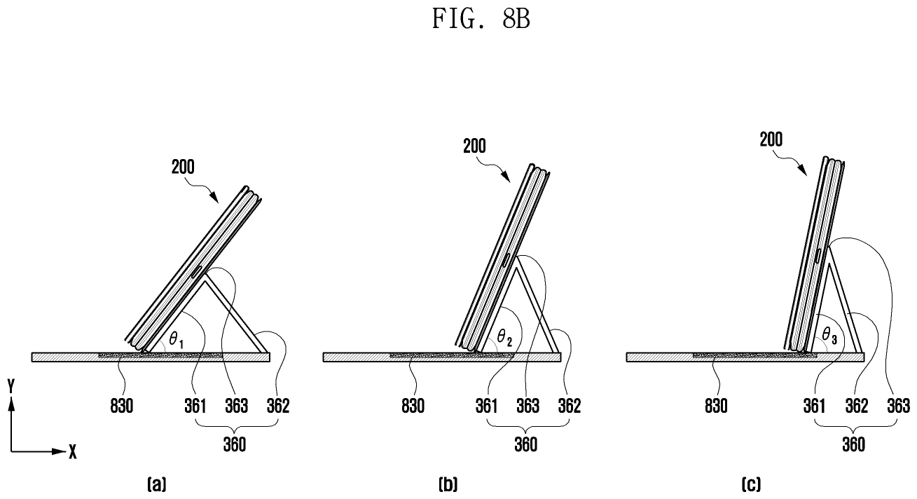

FIGS. 8A and 8B are diagrams illustrating example adjustment of a standing angle of the foldable electronic device through the foldable keyboard cover according to various embodiments.

According to various embodiments, as illustrated in FIG. 8A, a stand support part 810 may include at least one protrusion shape protruded with respect to the foldable keyboard cover. The stand support part 810 may be provided in plural, and may be arranged at specified intervals in an X direction in FIG. 8A. An angle between the foldable electronic device and the foldable keyboard cover may be adjusted based on a selected stand support part 810 of the plurality of stand support parts 810. For example, if a stand support part 810-1 supports the foldable electronic device as in (a) of FIG. 8A, an angle between the foldable electronic device and the foldable keyboard cover may become θ₁. If a stand support part 810-2 supports the foldable electronic device as in (b) of FIG. 8A, an angle between the foldable electronic device and the foldable keyboard cover may become θ₂. If a stand support part 810-3 supports the foldable electronic device as in (c) of FIG. 8A, an angle between the foldable electronic device and the foldable keyboard cover may become θ₃. Since θ₁<θ₂<θ₃, a standing angle of the foldable electronic device may be most gentle in the state of (a) of FIG. 8A, and a standing angle of the foldable electronic device may be the steepest in the state of (c) of FIG. 8A. A user may adjust the standing angle of the foldable electronic device depending on his or her convenience.

According to various embodiments, as illustrated in FIG. 8B, a stand support part 830 may include a non-slip pad formed in at least a part of the foldable keyboard cover. The non-slip pad may come into contact with one surface of the foldable electronic device and support the foldable electronic device by preventing and/or reducing the slip of the foldable electronic device. A standing angle of the foldable electronic device may be continuously adjusted in the section in which the stand support part 830 has been formed. For example, if the stand support part 830 supports the foldable electronic device at a point such as (a) of FIG. 8B, an angle between the foldable electronic device and the foldable keyboard cover may become θ₁. If the stand support part 830 supports the foldable electronic device at a point such as (b) of FIG. 8B, an angle between the foldable electronic device and the foldable keyboard cover may become θ₂. If the stand support part 830 supports the foldable electronic device at a point such as (c) of FIG. 8B, an angle between the foldable electronic device and the foldable keyboard cover may become θ₃. Since θ₁<θ₂<θ₃, the standing angle of the foldable electronic device may be most gentle in the case of (a) of FIG. 8B, and the standing angle of the foldable electronic device may be the steepest in the state of (c) of FIG. 8B. A user may adjust the standing angle of the foldable electronic device depending on his or her convenience.

A foldable keyboard cover configured to be attached to an electronic device comprising a first housing and a second housing connected to be foldable by a hinge part according to various example embodiments of the disclosure includes: a first cover configured to face the first housing of the electronic device and including a first attachment part configured to be attached to the first housing, a second cover configured to face the second housing of the electronic device and including a second attachment part configured to be attached to the second housing, a first folding part configured to face the hinge part of the electronic device and to connect the first cover and the second cover to be foldable about a first folding axis, and a physical keyboard including a first keyboard disposed in at least some area of the first cover and a second keyboard disposed in at least some area of the second cover. The first folding part may comprise a material having an elastic force wherein the first cover and the second cover are configured to cover the first housing and the second housing in a state in which the first housing of the electronic device and the second housing are folded.

Furthermore, the first folding part may be configured to be elastically deformed in a direction perpendicular to the first folding axis.

Furthermore, the foldable keyboard cover may further include a cover stand configured to support the electronic device at a specified angle with respect to the first cover and the second cover.

Furthermore, the cover stand may include a first support part disposed to correspond to at least some area of the first cover, a second support part connected to the first cover, and a second folding part configured to connect the first support part and the second support part to be foldable about a second folding axis perpendicular to the first folding axis. The first attachment part of the first cover may include a first standing attachment part disposed in the first support part of the cover stand and configured to be attached to at least some area of the first housing of the electronic device and a second standing attachment part disposed in the second support part of the cover stand and configured to be attached to at least some area of the first housing of the electronic device.

Furthermore, the first standing attachment part may be configured to be attached to the electronic device with an attachment force stronger than an attachment force of second standing attachment part to the electronic device.

Furthermore, the first support part of the cover stand may be configured to be disposed to cover a first keyboard of the physical keyboard.

Furthermore, the foldable keyboard cover may further include a stand support part formed in some area of at least one of the first cover and the second cover wherein the foldable keyboard cover is configured to be fixed in a state in which the electronic device forms a specified angle with the first cover and the second cover.

Furthermore, the stand support part may have a protrusion shape elongated in a direction perpendicular to the first folding axis in the electronic device, the first cover and the second cover and protruding and formed in a direction in which the physical keyboard is disposed in the first cover and the second cover.

Furthermore, the stand support parts may be disposed at specified intervals in the direction of the first folding axis so that an angle formed by the electronic device, and the first cover and the second cover is changed.

Furthermore, the stand support part may comprise a non-slip pad formed in at least some area of the first cover and the second cover.

A foldable keyboard cover configured to be attached to an electronic device in which a first housing and a second housing are connected to be foldable by a hinge part according to various example embodiments includes: a first cover configured to face the first housing of the electronic device and including a first attachment part configured to be attached to the first housing, a second cover configured to face the second housing of the electronic device and including a second attachment part configured to be attached to the second housing, a first folding part configured to face the hinge part of the electronic device and to connect the first cover and the second cover to be foldable about a first folding axis, and a physical keyboard including a first keyboard disposed in at least some area of the first cover and a second keyboard disposed in at least some area of the second cover. The first attachment part of the first cover and the second attachment part of the second cover may be configured to be attached to the first housing and second housing of the electronic device on a surface opposite to a surface on which a display of the electronic device is disposed.

Furthermore, the first folding part may further include a reinforcement member comprising an elastic material configured to permit folding of the first cover and the second cover, and pressurizing the first cover and the second cover in a direction perpendicular to the first folding axis in the state in which the first cover and the second cover are unfolded.

Furthermore, the second attachment part of the second cover may be elongated and formed in a direction perpendicular to the first folding axis wherein the second cover is configured to slip over the second housing in the state in which the end of the second cover has been matched with the end of the second housing of the electronic device based on the first cover and the second cover being folded or unfolded about the first folding axis, and the second attachment parts are arranged at specified intervals in the direction of the first folding axis.

Furthermore, the foldable keyboard cover may further include a cover stand configured to support the electronic device at a specified angle with respect to the first cover and the second cover.

Furthermore, the cover stand may include a first support part disposed to correspond to at least some area of the first cover, a second support part connected to the first cover, and a second folding part configured to connect the first support part and the second support part to be foldable about a second folding axis perpendicular to the first folding axis. The first attachment part of the first cover may include a first standing attachment part disposed in the first support part of the cover stand and configured to be attached to at least some area of the first housing of the electronic device and a second standing attachment part disposed in the second support part of the cover stand and configured to be attached to at least some area of the first housing of the electronic device.

Furthermore, the first standing attachment part may be configured to be attached to the electronic device with an attachment force stronger than an attachment force attaching the second standing attachment part to the electronic device.

Furthermore, the foldable keyboard cover may further include a stand support part formed in some area of at least one of the first cover and the second cover wherein the foldable keyboard cover is configured to form a specified angle along with the first cover and the second cover.

Furthermore, the stand support part may have a protrusion shape elongated in a direction perpendicular to the first folding axis in the electronic device, the first cover and the second cover and protruding and formed in a direction in which the physical keyboard is disposed in the first cover and the second cover.

Furthermore, the stand support parts may be disposed at specified intervals in the direction of the first folding axis so that an angle formed by the electronic device, and the first cover and the second cover is changed.

Furthermore, the stand support part may comprise a non-slip pad formed in at least some area of the first cover and the second cover.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A foldable keyboard cover configured to be attached to an electronic device in which a first housing and a second housing are connected to be foldable by a hinge part, the foldable keyboard cover comprising:
a first cover configured to face the first housing of the electronic device and comprising a first attachment part configured to be attached to the first housing;
a second cover configured to face the second housing of the electronic device and comprising a second attachment part configured to be attached to the second housing;
a first folding part configured to face the hinge part of the electronic device and connect the first cover and the second cover to be foldable about a first folding axis; and
a physical keyboard comprising a first keyboard disposed in at least some area of the first cover and a second keyboard disposed in at least some area of the second cover,
wherein the first folding part comprises a material having an elastic force wherein the first cover and the second cover are configured to cover the first housing and the second housing in a state in which the first housing of the electronic device and the second housing are folded.

2. The foldable keyboard cover of claim 1, wherein the first folding part is configured to be elastically deformed in a direction perpendicular to the first folding axis.

3. The foldable keyboard cover of claim 1, further comprising a cover stand configured to support the electronic device at a specified angle with respect to the first cover and the second cover.

4. The foldable keyboard cover of claim 3, wherein:
the cover stand comprises a first support part disposed to correspond to at least some area of the first cover, a second support part connected to the first cover, and a second folding part configured to connect the first support part and the second support part to be foldable about a second folding axis perpendicular to the first folding axis, and
the first attachment part of the first cover comprises a first standing attachment part disposed in the first support part of the cover stand and configured to be attached to at least some area of the first housing of the electronic device and a second standing attachment part disposed in the second support part of the cover stand and configured to be attached to at least some area of the first housing of the electronic device.

5. The foldable keyboard cover of claim 4, wherein the first standing attachment part is configured to be attached to the electronic device with an attachment force stronger than an attachment force between the second standing attachment part and the electronic device.

6. The foldable keyboard cover of claim 4, wherein the first support part of the cover stand is disposed to cover a first keyboard of the physical keyboard.

7. The foldable keyboard cover of claim 1, further comprising a stand support part provided in some area of at least one of the first cover and the second cover configured to fix the electronic device at a specified angle with the first cover and the second cover.

8. The foldable keyboard cover of claim 7, wherein the stand support part includes a protrusion shape elongated in a direction perpendicular to the first folding axis in the electronic device, the first cover and the second cover and protruding and formed in a direction in which the physical keyboard is disposed in the first cover and the second cover.

9. The foldable keyboard cover of claim 8, wherein the stand support parts are disposed at specified intervals in a direction of the first folding axis and configured to change an angle formed by the electronic device, the first cover and the second cover.

10. The foldable keyboard cover of claim 7, wherein the stand support part comprises a non-slip pad disposed in at least some area of the first cover and the second cover.

11. A foldable keyboard cover configured to be attached to an electronic device in which a first housing and a second housing are connected to be foldable by a hinge part, the foldable keyboard cover comprising:
a first cover configured to face the first housing of the electronic device and comprising a first attachment part configured to be attached to the first housing;
a second cover configured to face the second housing of the electronic device and comprising a second attachment part configured to be attached to the second housing;
a first folding part configured to face the hinge part of the electronic device and to connect the first cover and the second cover to be foldable about a first folding axis; and
a physical keyboard comprising a first keyboard disposed in at least some area of the first cover and a second keyboard disposed in at least some area of the second cover,
wherein the first attachment part of the first cover and the second attachment part of the second cover are configured to be attached to the first housing and second housing of the electronic device on a surface opposite to a surface on which a display of the electronic device is disposed.

12. The foldable keyboard cover of claim 11, wherein the first folding part further comprises a reinforcement member comprising an elastic material configured to permit a folding of the first cover and the second cover, and to pressurize the first cover and the second cover in a direction perpendicular to the first folding axis in a state in which the first cover and the second cover have been unfolded.

13. The foldable keyboard cover of claim 11, wherein the second attachment part of the second cover is elongated and formed in a direction perpendicular to the first folding axis wherein the second cover is configured to slip over the second housing in a state in which an end of the second cover has been matched with an end of the second housing of the electronic device based on the first cover and the second cover being folded or unfolded about the first folding axis, and the second attachment parts are arranged at specified intervals in a direction of the first folding axis.

14. The foldable keyboard cover of claim 11, further comprising a cover stand configured to support the electronic device at a specified angle with respect to the first cover and the second cover.

15. The foldable keyboard cover of claim 14, wherein:
the cover stand comprises a first support part disposed to correspond to at least some area of the first cover, a second support part connected to the first cover, and a second folding part configured to connect the first support part and the second support part to be foldable about a second folding axis perpendicular to the first folding axis, and
the first attachment part of the first cover comprises a first standing attachment part disposed in the first support part of the cover stand and configured to be attached to at least some area of the first housing of the electronic device and a second standing attachment part disposed in the second support part of the cover stand and configured to be attached to at least some area of the first housing of the electronic device.
